(19) United States
(12) Patent Application Publication
(10) Pub. No.: US 2013/0228709 A1
(43) Pub. Date: Sep. 5, 2013

(54) TARGET SUPPLY DEVICE

(71) Applicant: GIGAPHOTON INC., Oyama-shi (JP)

(72) Inventors: Hiroshi UMEDA, Hiratsuka-shi (JP); Hakaru MIZOGUCHI, Oyama-shi (JP)

(73) Assignee: GIGAPHOTON INC., Oyama-shi (JP)

(21) Appl. No.: 13/689,393

(22) Filed: Nov. 29, 2012

(30) Foreign Application Priority Data
Mar. 5, 2012 (JP) 2012-047983

(51) Int. Cl. H01J 43/00

(52) U.S. Cl. CPC H01J 43/00
USPC 250/493.1

(57) ABSTRACT

A target supply device includes a reservoir for storing a liquid target material, a first electrode electrically connected to the liquid target material stored in the reservoir, a nozzle having a through-hole through which the liquid target material stored in the reservoir is discharged, a first power supply for applying a first potential to the first electrode, a circuit electrically connected to the first electrode and configured to suppress a potential variation of the first electrode, a second electrode provided to face the through-hole in the nozzle, and a second power supply for applying a second potential that is different from the first potential to the second electrode.

### CROSS-REFERENCE TO RELATED APPLICATION

The present application claims priority from Japanese Patent Application No. 2012-047983 filed Mar. 5, 2012.

### BACKGROUND

1. Technical Field

The present disclosure relates to target supply devices.

2. Related Art

In recent years, semiconductor production processes have become capable of producing semiconductor devices with increasingly fine feature sizes, as photolithography has been making rapid progress toward finer fabrication. In the next generation of semiconductor production processes, microfabrication with feature sizes at 60 nm to 45 nm, and further, microfabrication with feature sizes of 32 nm or less will be required. In order to meet the demand for microfabrication with feature sizes of 32 nm or less, for example, an exposure apparatus is needed which combines a system for generating EUV light at a wavelength of approximately 13 nm with a reduced projection reflective optical system.

Three kinds of systems for generating EUV light are known in general, which include a Laser Produced Plasma (LPP) type system in which plasma is generated by irradiating a target material with a laser beam, a Discharge Produced Plasma (DPP) type system in which plasma is generated by electric discharge, and a Synchrotron Radiation (SR) type system in which orbital radiation is used to generate plasma.

### SUMMARY

A target supply device according to one aspect of the present disclosure may include a reservoir configured to store a liquid target material, a first electrode electrically connected to the liquid target material stored in the reservoir, a nozzle having a through-hole through which the liquid target material stored in the reservoir is discharged, a first power supply configured to apply a first potential to the first electrode, a circuit electrically connected to the first electrode and configured to suppress a potential variation of the first electrode, a second electrode provided to face the through-hole in the nozzle, and a second power supply configured to apply a second potential that is different from the first potential to the second electrode.

### BRIEF DESCRIPTION OF THE DRAWINGS

Hereinafter, selected embodiments of the present disclosure will be described with reference to the accompanying drawings.

FIG. 1 schematically illustrates a configuration of an exemplary LPP-type EUV light generation system.

FIG. 2 is a partial sectional view illustrating an exemplary configuration of an EUV light generation apparatus including a target supply device according to a first embodiment of the present disclosure.

FIG. 3A is a sectional view illustrating the target supply device shown in FIG. 2 and peripheral components thereof.

FIG. 3B is a waveform diagram showing potentials applied to electrodes in the target supply device shown in FIG. 2.

FIG. 4 is an equivalent circuit diagram showing one example of a potential variation control circuit used in the target supply device according to the first embodiment.

FIG. 5 is an equivalent circuit diagram showing another example of a potential variation control circuit used in the target supply device according to the first embodiment.

FIG. 6A is a partial sectional view illustrating a target supply device according to a second embodiment of the present disclosure and peripheral components thereof.

FIG. 6B is a waveform diagram showing potentials applied to electrodes in the target supply device shown in FIG. 6A.

FIG. 7 is a partial sectional view illustrating a target supply device according to a third embodiment of the present disclosure and peripheral components thereof.

FIG. 8 is a diagram for describing a method for controlling the direction of a target.

FIG. 9 is a partial sectional view illustrating a target supply device according to a fourth embodiment of the present disclosure and peripheral components thereof.

### DETAILED DESCRIPTION

Hereinafter, selected embodiments of the present disclosure will be described in detail with reference to the accompanying drawings. The embodiments described below are merely illustrative in nature and do not limit the scope of this disclosure. Further, the configuration(s) and operation(s) described in each embodiment are not all essential in implementing the present disclosure. Note that like elements are referenced by like reference numerals and characters, and duplicate descriptions thereof will be omitted herein.

### CONTENTS

### 1. Overview

### 2. Overview of EUV Light Generation System

### 2.1 Configuration

### 2.2 Operation

### 3. Target Supply Device Including Potential Variation Control Circuit: First Embodiment

### 3.1 Configuration

### 3.2 Operation

### 3.3 Examples of Potential Variation Control Circuit

### 4. Target Supply Device: Second Embodiment

### 5. Target Supply Device: Third Embodiment

### 5.1 Configuration

### 5.2 Operation

### 6. Target Supply Device: Fourth Embodiment

### 1. Overview

In an LPP type EUV light generation apparatus, a target supply device may supply a target to a plasma generation region inside a chamber, and the target may be irradiated with a pulse laser beam in the plasma generation region. Upon being irradiated with the pulse laser beam, the target may be turned into plasma, and EUV light may be emitted from the plasma.

The target supply device may include a reservoir for storing a target material in a molten state, a first electrode electrically connected to the molten target material, and a first power supply for applying a first potential to the first electrode. The target supply device may further include a second electrode provided to face a nozzle of the reservoir and a second power supply for applying a second potential that is different from the first potential to the second electrode.

A target outputted through the nozzle may be charged by a potential difference between the first and second electrodes. The speed and the trajectory of the charged target may be controlled through a potential gradient along a path from the nozzle to the plasma generation region.

However, plasma that emits EUV light may include charged particles such as electrons and ions of the target material. When these charged particles reach the nozzle of the target supply device, the potential of the first electrode may change unintentionally. When the potential of the first electrode changes, a charge given to the target may change as well, and the speed and the trajectory of the target may become unstable. As a result, the position at which EUV light emitting plasma is generated may change unintentionally.

According to one or more embodiments of the present disclosure, the target supply device may further include a circuit electrically connected to the first electrode and configured to control a variation in the potential of the first electrode. Thus, a variation in a charge given to a target may be suppressed, and the stability of the position at which EUV light is emitted may be improved.

### 2. Overview of EUV Light Generation System

### 2.1 Configuration

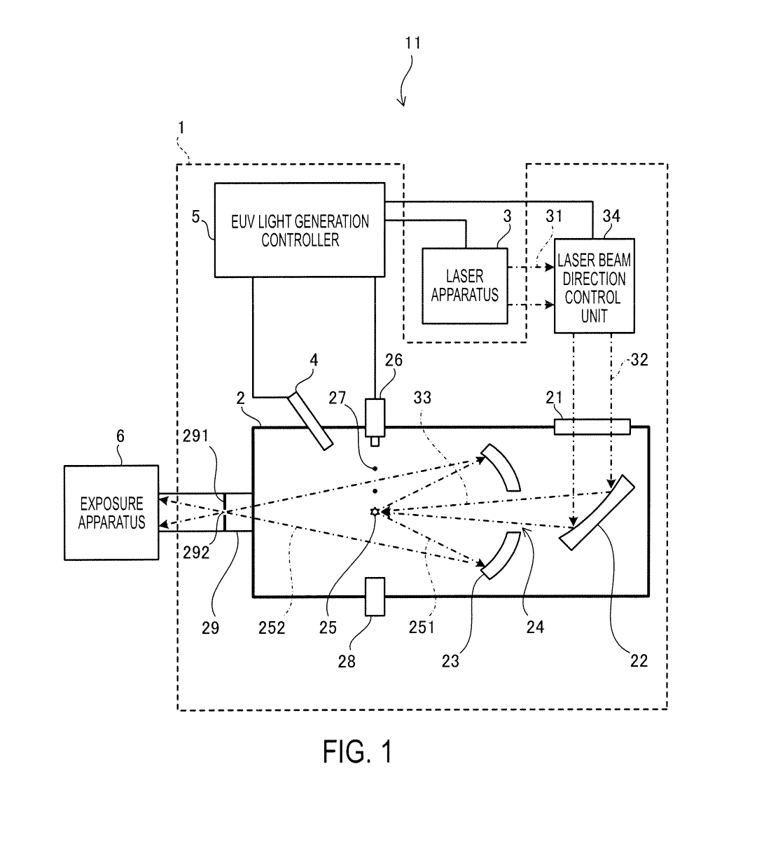

FIG. 1 schematically illustrates an exemplary configuration of an LPP type EUV light generation system. An EUV light generation apparatus 1 may be used with at least one laser apparatus 3. Hereinafter, a system that includes the EUV light generation apparatus 1 and the laser apparatus 3 may be referred to as an EUV light generation system 11. As shown in FIG. 1 and described in detail below, the EUV light generation system 11 may include a chamber 2 and a target supply device 26. The chamber 2 may be sealed airtight. The target supply device 26 may be mounted onto the chamber 2, for example, to penetrate a wall of the chamber 2. A target material to be supplied by the target supply device 26 may include, but is not limited to, tin, terbium, gadolinium, lithium, xenon, or any combination thereof.

The chamber 2 may have at least one through-hole or opening formed in its wall, and a pulse laser beam 32 may travel through the through-hole/opening into the chamber 2. Alternatively, the chamber 2 may have a window 21, through which the pulse laser beam 32 may travel into the chamber 2. An EUV collector mirror 23 having a spheroidal surface may, for example, be provided in the chamber 2. The EUV collector mirror 23 may have a multi-layered reflective film formed on the spheroidal surface thereof. The reflective film may include a molybdenum layer and a silicon layer, which are alternately laminated. The EUV collector mirror 23 may have a first focus and a second focus, and may be positioned such that the first focus lies in a plasma generation region 25 and the second focus lies in an intermediate focus (IF) region 292 defined by the specifications of an external apparatus, such as an exposure apparatus 6. The EUV collector mirror 23 may have a through-hole 24 formed at the center thereof so that a pulse laser beam 33 may travel through the through-hole 24 toward the plasma generation region 25.

The EUV light generation system 11 may further include an EUV light generation controller 5 and a target sensor 4. The target sensor 4 may have an imaging function and detect at least one of the presence, trajectory, position, and speed of a target 27.

Further, the EUV light generation system 11 may include a connection part 29 for allowing the interior of the chamber 2 to be in communication with the interior of the exposure apparatus 6. A wall 291 having an aperture may be provided in the connection part 29. The wall 291 may be positioned such that the second focus of the EUV collector mirror 23 lies in the aperture formed in the wall 291.

The EUV light generation system 11 may also include a laser beam direction control unit 34, a laser beam focusing mirror 22, and a target collector 28 for collecting targets 27. The laser beam direction control unit 34 may include an optical element (not separately shown) for defining the direction into which the pulse laser beam 32 travels and an actuator (not separately shown) for adjusting the position and the orientation or posture of the optical element.

### 2.2 Operation

With continued reference to FIG. 1, a pulse laser beam 31 outputted from the laser apparatus 3 may pass through the laser beam direction control unit 34 and be outputted therefrom as the pulse laser beam 32 after having its direction optionally adjusted. The pulse laser beam 32 may travel through the window 21 and enter the chamber 2. The pulse laser beam 32 may travel inside the chamber 2 along at least one beam path from the laser apparatus 3, be reflected by the laser beam focusing mirror 22, and strike at least one target 27 as a pulse laser beam 33.

The target supply device 26 may be configured to output the target(s) 27 toward the plasma generation region 25 in the chamber 2. The target 27 may be irradiated with at least one pulse of the pulse laser beam 33. Upon being irradiated with the pulse laser beam 33, the target 27 may be turned into plasma, and rays of light 251 including EUV light may be emitted from the plasma. At least the EUV light included in the light 251 may be reflected selectively by the EUV collector mirror 23. EUV light 252, which is the light reflected by the EUV collector mirror 23, may travel through the intermediate focus region 292 and be outputted to the exposure apparatus 6. Here, the target 27 may be irradiated with multiple pulses included in the pulse laser beam 33.

The EUV light generation controller 5 may be configured to integrally control the EUV light generation system 11. The EUV light generation controller 5 may be configured to process image data of the target 27 captured by the target sensor 4. Further, the EUV light generation controller 5 may be configured to control at least one of: the timing when the target 27 is outputted and the direction into which the target 27 is outputted. Furthermore, the EUV light generation controller 5 may be configured to control at least one of: the timing when the laser apparatus 3 oscillates, the direction in which the pulse laser beam 31 travels, and the position at which the pulse laser beam 33 is focused. It will be appreciated that the various controls mentioned above are merely examples, and other controls may be added as necessary.

### 3. Target Supply Device Including Potential Variation Control Circuit

### 3.1 Configuration

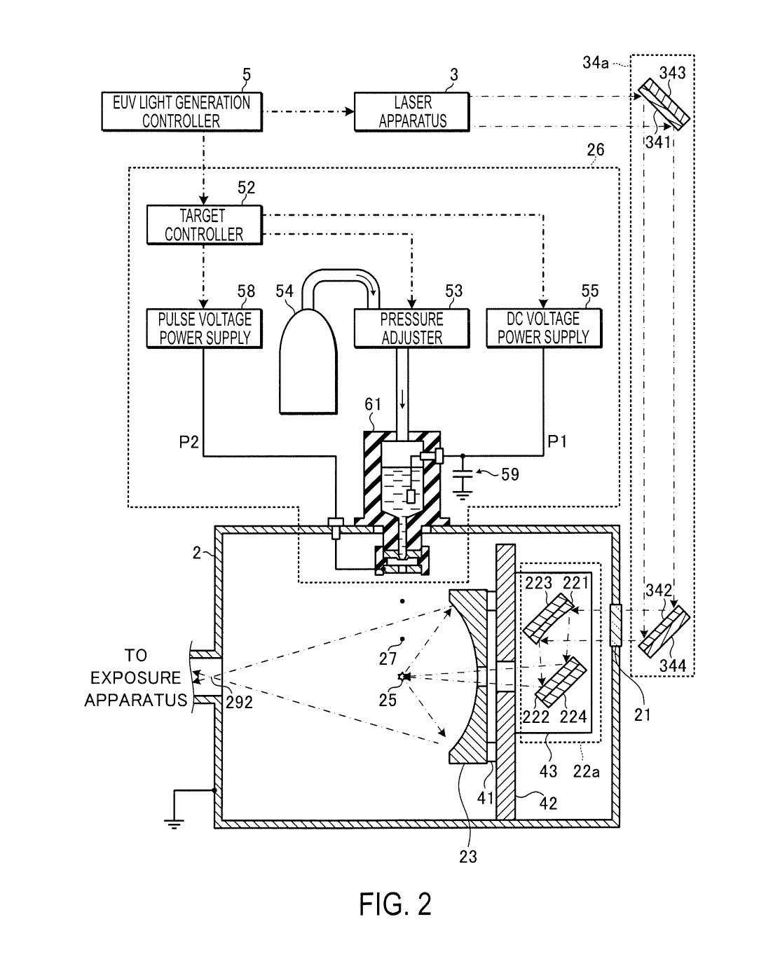

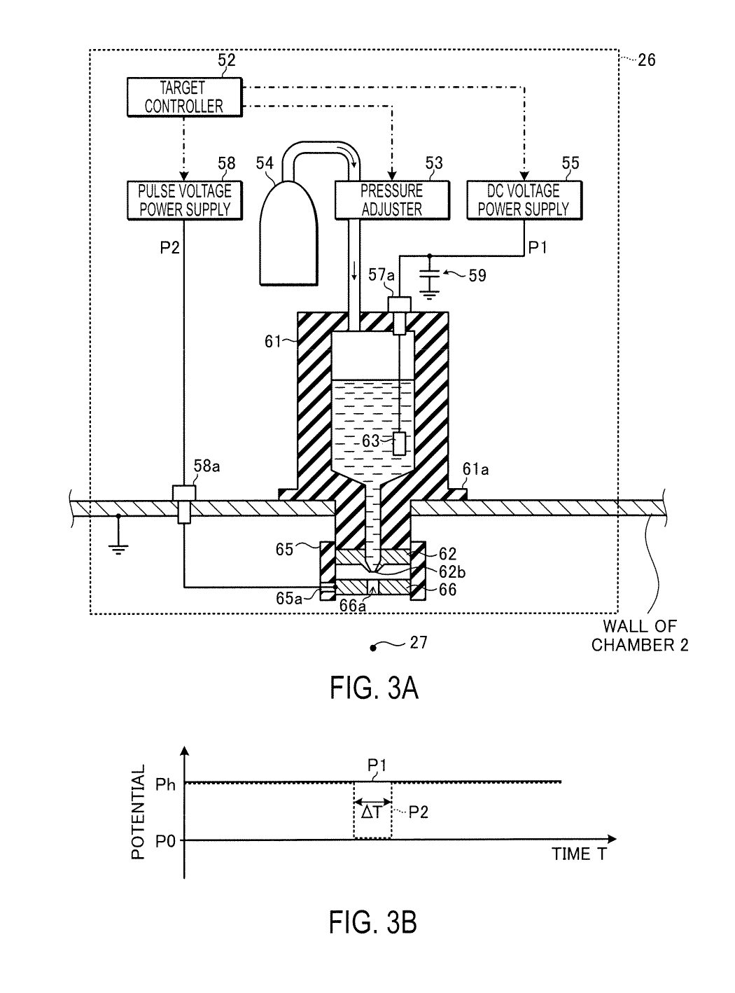

FIG. 2 is a partial sectional view illustrating an exemplary configuration of an EUV light generation apparatus including a target supply device according to a first embodiment of the present disclosure. FIG. 3A is a sectional view illustrating a target supply device shown in FIG. 2 and peripheral components thereof. FIG. 33 is a waveform diagram showing potentials applied to electrodes in the target supply device shown in FIG. 2.

As shown in FIG. 2, a laser beam focusing optical system 22a, the EUV collector mirror 23, an EUV collector mirror mount 41, and plates 42 and 43 may be provided inside the chamber 2.

The plate 42 may be attached to the chamber 2, and the plate 43 may be attached to the plate 42. The EUV collector mirror 23 may be attached to the plate 42 through the EUV collector mirror mount 41.

The laser beam focusing optical system 22a may include an off-axis paraboloidal mirror 221, a flat mirror 222, and holders 223 and 224 for the respective mirrors 221 and 222. The off-axis paraboloidal mirror 221 and the flat mirror 222 may be fixed to the plate 43 through the respective mirror holders 223 and 224 such that a pulse laser beam reflected sequentially by the mirrors 221 and 222 is focused in the plasma generation region 25.

A beam steering unit 34a and the EUV light generation controller 5 may be provided outside the chamber 2. The beam steering unit 34a may include high-reflection mirrors 341 and 342 and holders 343 and 344 for holding the respective high-reflection mirrors 341 and 342.

With reference to FIGS. 2 and 3A, the target supply device 26 may be mounted to the chamber 2. The target supply device 26 may include a reservoir 61, a target controller 52, a pressure adjuster 53, an inert gas cylinder 54, a DC voltage power supply 55, and a pulse voltage power supply 58. The target supply device 26 may further include a nozzle plate 62, a first electrode 63, an electrically insulating member 65, and a second electrode 66.

The reservoir 61 may be configured to store a target material in a molten state. A heater (not separately shown) and a heater power supply (not separately shown) may be provided to keep the target material in a molten state. The reservoir 61 may be formed of a material that is not susceptible to reacting with a target material and that has electrically non-conductive properties. For example, when tin is used as a target material, the reservoir 61 may be formed of quartz (SiO₂), alumina ceramics (Al₂O₃), or the like. A through-hole may be formed in the wall of the chamber 2, and a flange 61a of the reservoir 61 may be fixed to surround the through-hole.

The nozzle plate 62 may be fixed to an output end of the reservoir 61. The nozzle plate 62 may be formed of a material having electrically conductive properties or a material having electrically non-conductive properties. The nozzle plate 62 may have a through-hole 62b formed therein through which a liquid target material passes. The nozzle plate 62 may have a protrusion formed at an output side, and the aforementioned through-hole 62b may open at the protrusion. Thus, when a potential difference is generated between the first electrode 63 and the second electrode 66, the electric field may be enhanced at the target material in the aforementioned through-hole 62b.

The electrically insulating member 65 may be cylindrical in shape and fixed to the reservoir 61 to surround a part of the output end of the reservoir 61. The electrically insulating member 65 may hold the nozzle plate 62 and the second electrode 66 thereinside to provide electrical insulation between the nozzle plate 62 and the second electrode 66. The second electrode 66 may be provided to face the outer surface of the nozzle plate 62. The second electrode 66 may have a through-hole 66a formed therein through which targets 27 may pass.

The target controller 52 may be configured to output control signals to the pressure adjuster 53, the DC voltage power supply 55, and the pulse voltage power supply 58, respectively. The inert gas cylinder 54 may be connected to the pressure adjuster 53 through a pipe. The pressure adjuster 53 may be in communication with the interior of the reservoir 61 through another pipe.

The output terminal of the DC voltage power supply 55 may be electrically connected to a high-voltage cable, and this high-voltage cable may be electrically connected to the first electrode 63 inside the reservoir 61 through a feedthrough 57a provided in the reservoir 61. The first electrode 63 may be in contact with the target material stored in the reservoir 61.

The output terminal of the pulse voltage power supply 58 may be electrically connected to the second electrode 66 through a feedthrough 58a provided in the chamber 2 and through a through-hole 65a provided in the electrically insulating member 65.

### 3.2 Operation

The pressure adjuster 53 may be configured to adjust the pressure of an inert gas supplied from the inert gas cylinder 54 in accordance with a control signal from the target controller 52. The pressure-adjusted inert gas may then be introduced into the reservoir 61 to pressurize the molten target material in the reservoir 61. As the target material is pressurized, the target material may protrude slightly through the through-hole 62b at the protrusion.

The DC voltage power supply 55 may apply a potential P1 to the target material through the first electrode 63 in the reservoir 61 in accordance with a control signal from the target controller 52. The pulse voltage power supply 58 may apply a pulsed voltage P2 to the second electrode 66 in accordance with a control signal from the target controller 52. Accordingly, the target material may be charged, and an electric field may be generated between the target material and the second electrode 66. As a result, the Coulomb force may be generated between the target material and the second electrode 66.

In particular, as stated above, the electric field may be enhanced at the target material protruding from the through-hole 62b at the protrusion, and thus the Coulomb force may be enhanced between the target material protruding from the through-hole 62b at the protrusion and the second electrode 66. This Coulomb force may cause a target 27 to be outputted from the through-hole 62b at the protrusion in the form of a charged droplet.

The target controller 52 may be configured to control the pressure adjuster 53 and the pulse voltage power supply 58 so that a target 27 is outputted at a timing instructed by the EUV light generation controller 5. A target 27 outputted into the chamber 2 may be supplied to the plasma generation region 25 inside the chamber 2.

A pulse laser beam outputted from the laser apparatus 3 may be reflected sequentially by the high-reflection mirrors 341 and 342, and may enter the laser beam focusing optical system 22a through the window 21. The pulse laser beam that has entered the laser beam focusing optical system 22a may be reflected sequentially by the off-axis paraboloidal mirror 221 and the flat mirror 222 and be focused in the plasma generation region 25. The EUV light generation controller 5 may control the laser apparatus 3 and the target supply device 26 such that a target 27 outputted from the target supply device 26 is irradiated with the pulse laser beam at a timing at which the target 27 reaches the plasma generation region 25.

With reference to FIG. 3B, the DC voltage power supply 55 may retain a potential P1 of the target material in the reservoir 61 at a predetermined potential Ph of, for example, 20 kV. The pulse voltage power supply 58 may first retain a potential P2 of the second electrode 66 at a predetermined potential Ph of, for example, 20 kV, and change the potential P2 to a potential P0 of, for example, 0 V when a target 27 is to be outputted. Then, the pulse voltage power supply 58 may change the potential P2 back to the potential Ph after a predetermined time ΔT elapses. The predetermined time ΔT may correspond to a pulse duration. Here, the potential Ph and the potential P0 may satisfy a relationship of Ph>P0. The potential P0 may be the same as the potential of the chamber 2, and the potential of the chamber 2 may be a ground potential of 0 V.

When a target 27 outputted from the target supply device 26 is irradiated with a pulse laser beam, EUV light emitting plasma may be generated from the target 27. If charged particles contained in the plasma reach the nozzle plate 62 of the target supply device 26 or the vicinity thereof, the potential P1 of the target material may temporarily change. In this case, even if the potential P2 of the second electrode 66 is controlled in order to output a subsequent target 27, a potential difference between the potential P1 of the target material and the potential P2 of the second electrode 66 may not be controlled to a desired potential difference. Accordingly, the speed and/or the trajectory of the subsequent target(s) 27 may vary.

Thus, a potential variation control circuit 59 (see FIG. 3A) may be connected to the first electrode 63. The potential variation control circuit 59 may be connected to the first electrode 63 through a wire connecting the first electrode 63 to the DC voltage power supply 55. In one embodiment, the potential variation control circuit 59 may be connected to a wire between the first electrode 63 and the DC voltage power supply 55 at a position closer to the first electrode 63.

### 3.3 Examples of Potential Variation Control Circuit

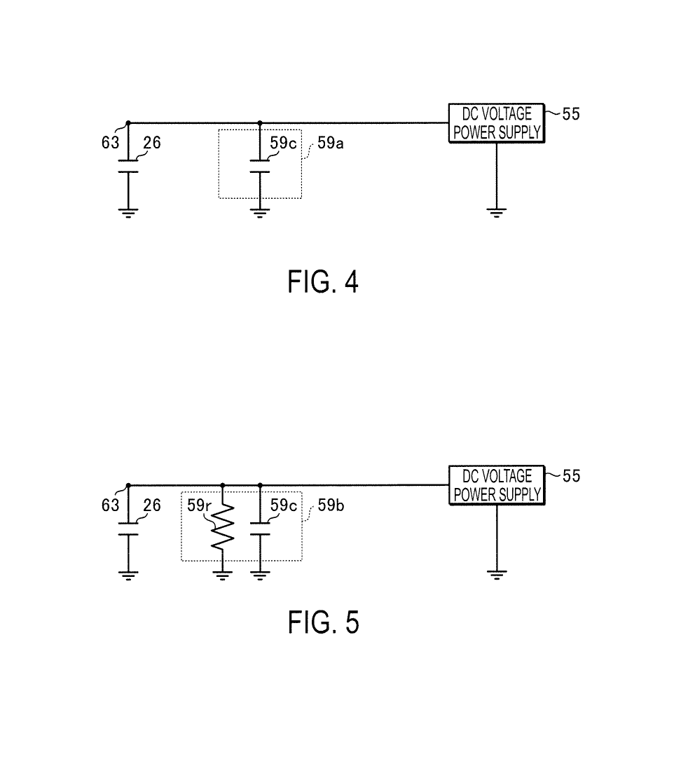

FIG. 4 is an equivalent circuit diagram showing one example of a potential variation control circuit used in the target supply device according to the first embodiment. In FIG. 4, the liquid target material in contact with the first electrode 63 and the wall of the chamber 2 connected to the potential P0 are electrically insulated from each other, and thus the target supply device 26 is expressed as a single capacitor.

A potential variation control circuit 59a may include a capacitor 59c connected at one terminal to the first electrode 63 and at the other terminal to the ground potential. The capacitor 59c may have capacitance in a range from 5 nF to 10 nF inclusive. When the potential of the first electrode 63 is to change, the capacitor 59c of the potential variation control circuit 59a may supply a charge to the first electrode 63 or accept a charge from the first electrode 63. Accordingly, a variation in the potential of the first electrode 63 may be controlled. That is, the potential variation control circuit 59a that includes the capacitor 59c may function as a low pass filter for suppressing a high-frequency component of a potential variation at the first electrode 63.

The above-described configuration may allow a potential difference between the potential P1 of the target material and the potential P2 of the second electrode 66 to be controlled to a desired potential difference. Accordingly, a variation in a charge given to a target 27 may be suppressed. As a result, a variation in the speed and/or the trajectory of targets 27 may be reduced.

FIG. 5 is an equivalent circuit diagram showing another example of a potential variation control circuit used in the target supply device according to the first embodiment. In FIG. 5 as well, the target supply device 26 is expressed as a single capacitor.

A potential variation control circuit 59b may include the capacitor 59c and a resistor 59r that is connected at one terminal to the first electrode 63 and at the other terminal to the ground potential. The resistor 59r may have a resistance in a range from 50 kΩ to 200 kΩ inclusive. With the resistor 59r being further included, a time constant of the potential variation control circuit 59b may be adjusted, and the potential variation of the first electrode 63 may further be suppressed.

### 4. Target Supply Device

### Second Embodiment

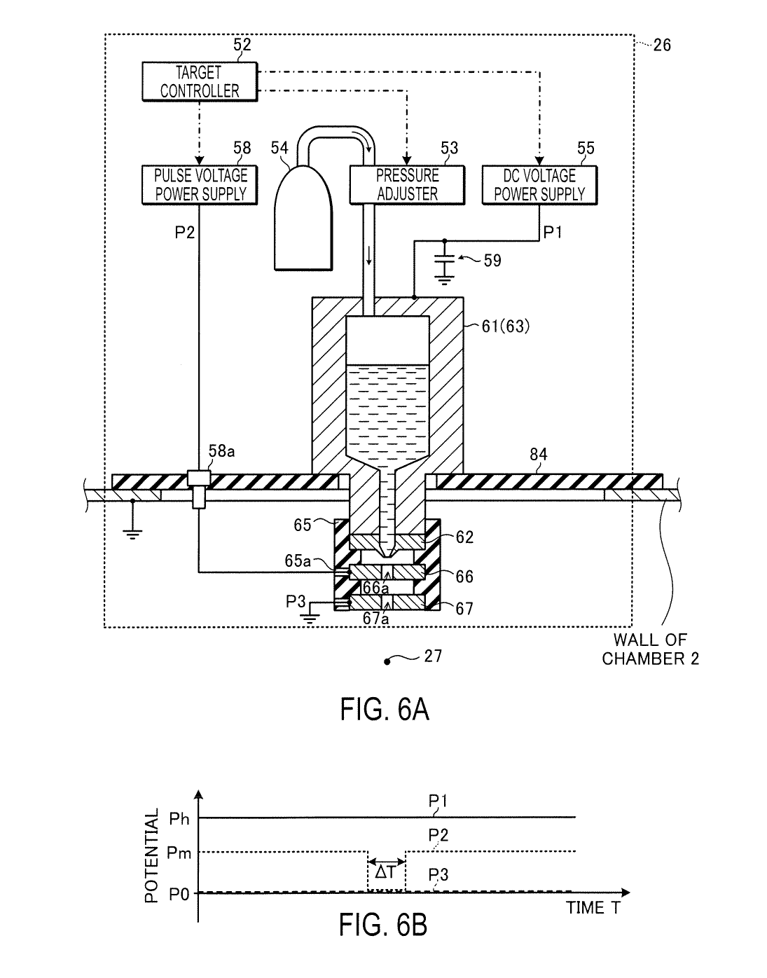

FIG. 6A is a partial sectional view illustrating a target supply device according to a second embodiment of the present disclosure and peripheral components thereof. FIG. 6B is a waveform diagram showing potentials applied to electrodes in the target supply device shown in FIG. 6A. In the second embodiment, a reservoir 61 may be formed of a material that is not susceptible to reacting with the target material and that has electrically conductive properties such as molybdenum (Mo) and tungsten (W). A third electrode 67 may further be provided downstream from the second electrode 66 in the direction in which the target 27 travels. The third electrode 67 may be held inside the electrically insulating member 65.

A through-hole may be formed in the wall of the chamber 2, and a flange 84 may be fixed to cover the through-hole in the chamber 2. A through-hole may be formed in the flange 84, and the reservoir 61 of the target supply device 26 may be fixed to the flange 84 to pass through the through-hole. The flange 84 may have electrically non-conductive properties. This configuration allows the reservoir 61 having electrically conductive properties to be electrically insulated from the chamber 2 having electrically conductive properties.

The feedthrough 57a (see FIG. 3A) may not be provided in the reservoir 61. In the second embodiment, the reservoir 61 may serve as the first electrode 63 and may be electrically in contact with the liquid target material.

The DC voltage power supply 55 may retain a potential P1 of the target material in the reservoir 61 at a predetermined potential Ph of, for example, 20 kV. The pulse voltage power supply 58 may first retain a potential P2 of the second electrode 66 at a potential Pm of, for example, 10 kV, and change the potential P2 to a potential P0 of, for example, 0 V when a target 27 is to be outputted. Then, the pulse voltage power supply 58 may change the potential P2 back to the potential Pm after a predetermined time ΔT elapses. The predetermined time ΔT may correspond to a pulse duration. Here, the potential Ph, the potential Pm, and the potential P0 may satisfy a relationship of Ph≧Pm>P0. The potential P0 may be the same of the potential of the chamber 2, and the potential of the chamber 2 may be a ground potential of 0 V.

Thus, a positively charged target 27 may be pulled out through the through-hole 62b in the nozzle plate 62. The positively charged target 27 may be pulled out toward the second electrode 66 to which a potential P2 that is lower than the potential P1 is applied, and may pass through the through-hole 66a in the second electrode 66.

A potential P3 of the third electrode 67 may be retained at the potential P0. Accordingly, the target 27 that has passed through the through-hole 66a may be accelerated toward the third electrode 67 to which the potential P0 that is lower than the potential of the second electrode 66 is applied.

In this way, the target 27 may be accelerated through a potential gradient formed along a path from the nozzle plate 62 to the third electrode 67, and may pass through a through-hole 67a formed in the third electrode 67. Along the path of the target 27 that has passed through the through-hole 67a, the potential gradient may be gradual since the potential of the chamber 2 is the ground potential. Accordingly, after passing through the through-hole 67a, the target 27 may travel inside the chamber 2 with momentum at the time of passing through the through-hole 67a.

In the second embodiment as well, since the potential variation control circuit 59 is connected to the reservoir 61, the potential variation of the reservoir 61 may be suppressed. According to this configuration, since a potential difference between the potential P1 of the target material and the potential P2 of the second electrode 66 may be controlled to a desired potential difference, a variation in a charge given to a target 27 may be suppressed. Accordingly, a variation in the speed of the target 27 accelerated through the third electrode 67 may be suppressed. The third electrode 67 may also be included in the target supply device according to the first embodiment.

### 5. Target Supply Device

### Third Embodiment

### 5.1 Configuration

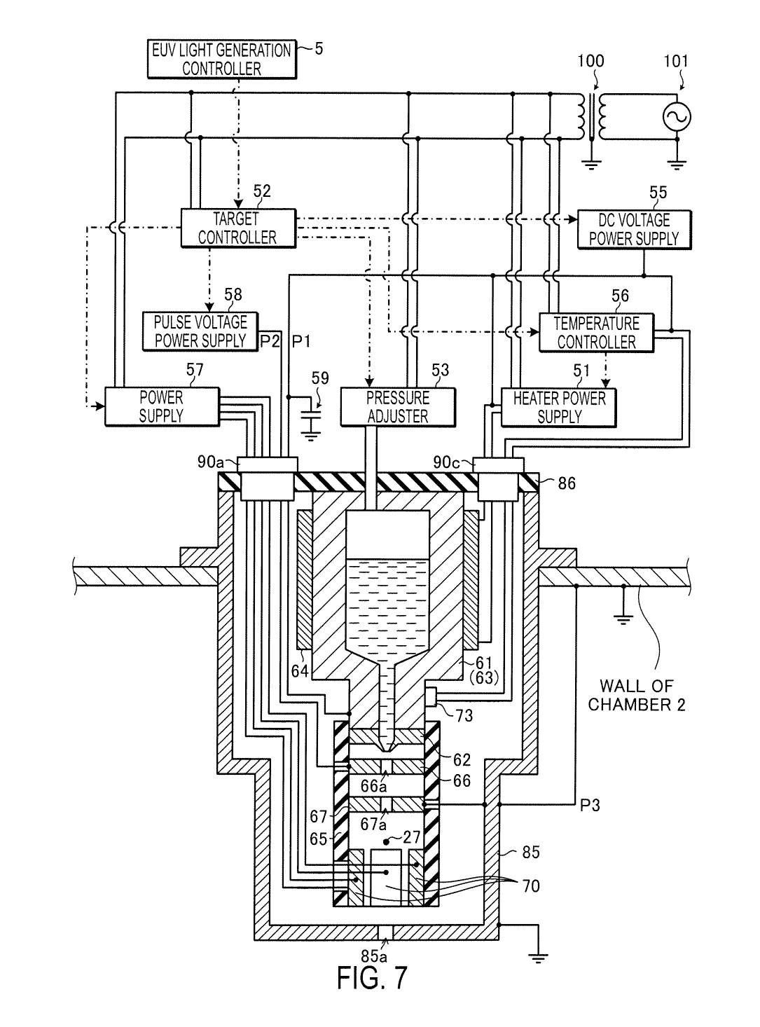

FIG. 7 is a partial sectional view illustrating a target supply device according to a third embodiment of the present disclosure and peripheral components thereof. In the third embodiment, the target supply device 26 may further include a cover 85 and fourth electrodes 70.

As shown in FIG. 7, the main constituent elements of the target supply device 26 such as the reservoir 61 may be housed in a shielding container formed by the cover 85 and a lid 86 attached to seal the cover 85. The cover 85 may be mounted to the wall of the chamber 2. The cover 85 may have a through-hole 85a formed therein through which targets 27 pass. The reservoir 61 may be mounted to the lid 86.

The cover 85 may be formed of an electrically conductive material such as metal and may have electrically conductive properties. The cover 85 may be electrically connected to the chamber 2. Alternatively, the cover 85 may be electrically connected to the chamber 2 through an electrically conductive connection member such as a wire. The chamber 2 may be electrically connected to the ground potential. An electrically non-conductive material such as mullite may be used as a material for the lid 86. Accordingly, the cover 85 and the reservoir 61 may be electrically insulated from each other. The cover 85 may serve to shield electrically non-conductive members such as the electrically insulating member 65 from charged particles emitted from plasma generated in the plasma generation region 25.

A plurality of fourth electrodes 70 may be provided downstream from the third electrode 67 in the direction in which the target 27 travels. In the third embodiment, two pairs of fourth electrodes 70 may be provided. The fourth electrodes 70 may be held by the electrically insulating member 65 to be electrically insulated from one another.

Wires for the fourth electrodes 70 may be electrically connected to a power supply 57 through a through-hole in the electrically insulating member 65 and through a feedthrough 90c provided in the lid 86. A wire for the third electrode 67 may be electrically connected to the cover 85 through another through-hole in the electrically insulating member 65. A wire for the second electrode 66 may be electrically connected to the pulse voltage power supply 58 through yet another through-hole in the electrically insulating member 65 and through a feedthrough 90a.

The reservoir 61 having electrically conductive properties may serve as the first electrode 63 to apply a potential to the target material. Alternatively, when the nozzle plate 62 has electrically conductive properties, the nozzle plate 62 may serve as the first electrode 63. A wire for the reservoir 61 may be electrically connected to the DC voltage power supply 55 through the feedthrough 90a.

The target supply device 26 may further include a heater 64, a heater power supply 51, a temperature sensor 73, and a temperature controller 56. The heater power supply 51 may be connected to the heater 64 with two wires through the feedthrough 90c. The temperature sensor 73 may be connected to the temperature controller 56 with two wires through the feedthrough 90c.

The heater 64 may be mounted to the outer surface of the reservoir 61 to heat the reservoir 61. The temperature sensor 73 may measure the temperature of the reservoir 61 and output a signal indicative of a measurement result. A signal from the temperature sensor 73 may be inputted to the temperature controller 56.

A control signal from the target controller 52 may be inputted to the temperature controller 56. The temperature controller 56 may output a drive signal to the heater power supply 51 in accordance with a signal from the temperature sensor 73 and a control signal from the target controller 52. The heater power supply 51 may supply power to the heater 64 in accordance with a drive signal from the temperature controller 56. Thus, the reservoir 61 may be heated by the heater 64 to a temperature equal to or higher than the melting point of the target material. As a result, the target material may be stored in the reservoir 61 in a molten state.

Each of the target controller 52, the pressure adjuster 53, the power supply 57, the temperature controller 56, and the heater power supply 51 may be connected to the secondary of an isolation transformer 100 and supplied with power from the isolation transformer 100. The primary of the isolation transformer 100 may be connected to an AC power supply 101. Each of the target controller 52, the pressure adjuster 53, the power supply 57, the temperature controller 56, and the heater power supply 51 may be retained at a potential equivalent to that of the target material. That is, each of the target controller 52, the pressure adjuster 53, the power supply 57, the temperature controller 56, and the heater power supply 51 may be electrically insulated from the chamber 2 and/or the EUV light generation controller 5. The target controller 52 and the EUV light generation controller 5 may be connected through an optical fiber for transmitting signals therebetween.

A wire connecting the reservoir 61 to the DC voltage power supply 55 may be connected to one of the two wires connecting the temperature controller 56 to the temperature sensor 73. The wire connecting the first electrode 63 to the DC voltage power supply 55 may further be connected to one of the two wires connecting the heater power supply 51 to the heater 64. Accordingly, an electric discharge between wires may be suppressed.

### 5.2 Operation

The target controller 52 may be configured to output control signals to the pressure adjuster 53, the DC voltage power supply 55, and the pulse voltage power supply 58, respectively. Thus, a charged target 27 may be pulled out through the through-hole 62b formed in the nozzle plate 62, and may pass through the through-hole 66a in the second electrode 66. The target 27 that has passed through the through-hole 66a may be accelerated through an electric field between the second electrode 66 and the third electrode 67 that is connected to the ground potential, and pass through the through-hole 67a in the third electrode 67.

The two pairs of fourth electrodes 70 may cause an electric field to act on the target 27 that has passed through the through-hole 67a to deflect the travel direction of the target 27. When a target 27 needs to be deflected, the target controller 52 may output a control signal to the power supply 57 to control a potential difference between each pair of the fourth electrodes 70. The power supply 57 may be configured to apply a potential difference between each pair of the fourth electrodes 70.

A target 27 may be deflected based on a control signal from the EUV light generation controller 5. Various signals may be transmitted between the EUV light generation controller 5 and the target controller 52. For example, the EUV light generation controller 5 may obtain information on the trajectory of a target 27 from a target sensor (not separately shown), and calculate a difference between the obtained trajectory and an ideal trajectory of a target 27. Then, the EUV light generation controller 5 may send a signal to the target controller 52 to control a voltage applied between each pair of the fourth electrodes 70 to bring the aforementioned difference closer to zero. A target 27 that has passed through the two pairs of the fourth electrodes 70 may then pass through the through-hole 85a in the cover 85.

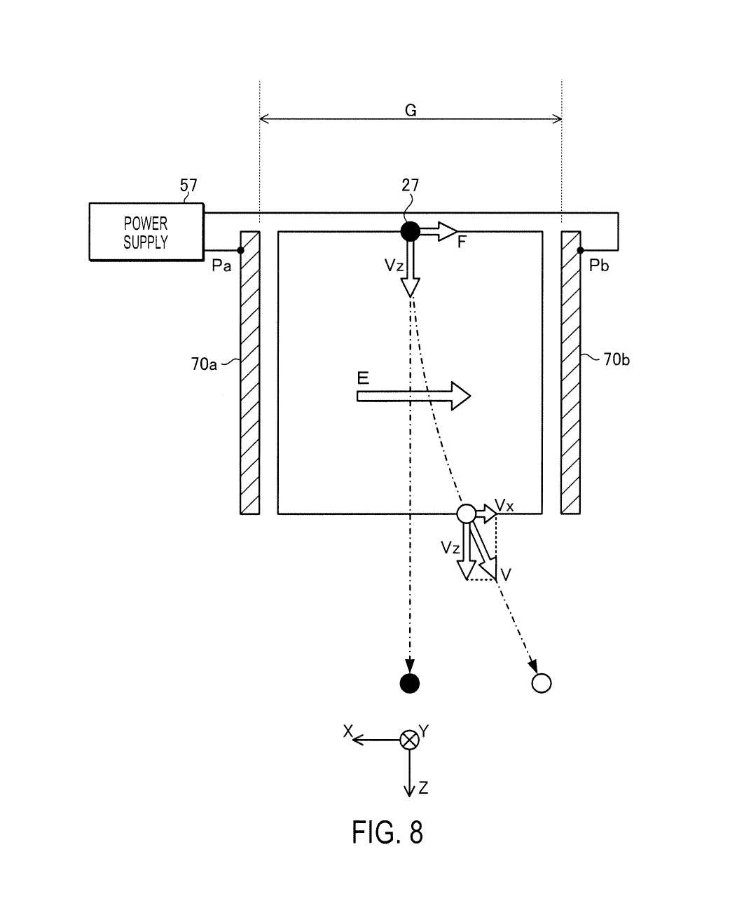

FIG. 8 is a diagram for discussing a method for deflecting a target. In an example below, the direction of a charged target 27 moving in the Z-direction may be deflected through an electric field in the X-direction using a pair of flat electrodes 70a and 70b.

A charged target 27 having a charge Q may be subjected to the Coulomb force F expressed in the following expression through an electric field E between the flat electrodes 70a and 70b:

F=QE

The following description assumes that the electric lines of force between the flat electrodes 70a and 70b are substantially parallel to one another at any given locations between the electrodes. The electric field E may be expressed in the following expression through a potential difference (Pa−Pb) between a potential Pa applied to the flat electrode 70a and a potential Pb applied to the flat electrode 70b, and a gap length G between the flat electrodes 70a and 70b:

E=(Pa−Pb)/G

When a target 27 enters the electric field with an initial speed V₀, the target 27 may be subjected to the Coulomb force in the X-direction, and thus the direction of the target 27 may be deflected. The target 27 may be accelerated in the X-direction by the Coulomb force F while moving in the Z-direction with a Z-direction velocity component V_{z} (V_{z}=V₀). The target 27 is subjected to the Coulomb force F while moving in the electric field. An acceleration a in the Z-direction at this time may be obtained from the expression below when a mass m of the target 27 is known:

F=ma

Further, an X-direction velocity component Vₓ when the target 27 exits the electric field may be obtained through the following expression:

Vₓ=aL/V_{z}

Here, L is the length of the electrodes 70 in the Z-direction.

A speed V of the target 27 when the target 27 exits the electric field is expressed in the following expression by the Z-direction velocity component V_{z} and the X-direction velocity component Vₓ:

V=(V_{z}²+Vₓ²)^{1/2}

In this way, providing a potential difference (Pa−Pb) to cause an electric field to act on a part of the trajectory of the target 27 may make it possible to deflect the direction of the target 27. Further, adjusting the potential difference (Pa−Pb) may make it possible to control the deflection amount. Through this control, the target 27 that exits the electric field may move at a speed V and arrives at a position at which the target 27 is to be irradiated with a pulse laser beam. Similarly, with respect to the Y-direction, the direction of the target 27 may be controlled by disposing a pair of flat electrodes in the Y-direction.

In the third embodiment as well, since the potential variation control circuit 59 is connected to the reservoir 61, the potential variation of the reservoir 61 may be suppressed. Accordingly, a potential difference between the potential P1 of the target material and the potential P2 of the second electrode 66 may be controlled to a desired potential difference, and a variation in a charge given to the target 27 may be suppressed. Thus, a variation in the speed of the target 27 accelerated through the third electrode 67 may be suppressed. Further, the trajectory of the target 27 may be controlled to a desired trajectory through the fourth electrodes 70. Here, the fourth electrodes 70 may be included in the target supply device according to the first or second embodiment.

### 6. Target Supply Device

### Fourth Embodiment

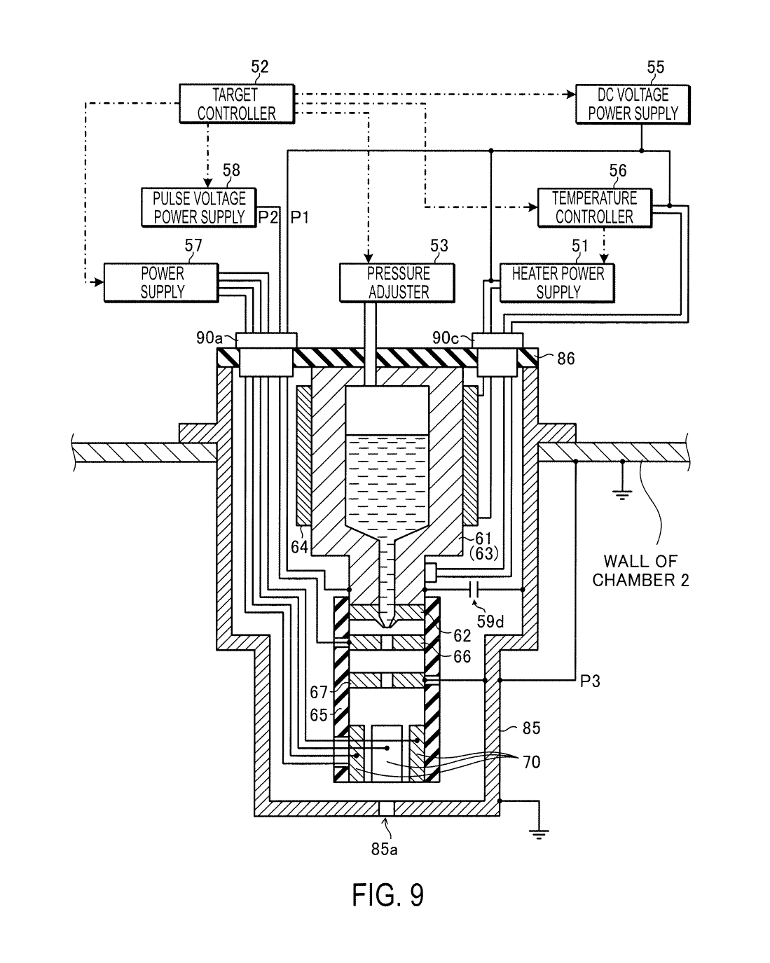

FIG. 9 is a partial sectional view illustrating a target supply device according to a fourth embodiment of the present disclosure and peripheral component thereof.

In the fourth embodiment, one of the terminals of a potential variation control circuit 59d may be in contact with the reservoir 61 having electrically conductive properties and may be electrically connected to a liquid target material through the reservoir 61. The reservoir 61 may serve as the first electrode 63. Accordingly, the one of the terminals of the potential variation control circuit 59d may be directly connected to the reservoir 61, instead of being connected to a wire connecting the DC voltage power supply 55 to the reservoir 61. The other terminal of the potential variation control circuit 59d may be connected to the cover 85.

In the fourth embodiment as well, since the potential variation control circuit 59d is connected to the reservoir 61, the potential variation of the reservoir 61 may be suppressed. Accordingly, a variation in the speed of the target 27 accelerated through the third electrode 67 may be suppressed. Further, the trajectory of the target 27 may be controlled to a desired trajectory through the fourth electrodes 70.

The above-described embodiments and the modifications thereof are merely examples for implementing the present disclosure, and the present disclosure is not limited thereto. Making various modifications according to the specifications or the like is within the scope of the present disclosure, and other various embodiments are possible within the scope of the present disclosure. For example, the modifications illustrated for particular ones of the embodiments can be applied to other embodiments as well (including the other embodiments described herein).

The terms used in this specification and the appended claims should be interpreted as “non-limiting.” For example, the terms “include” and “be included” should be interpreted as “including the stated elements but not limited to the stated elements.” The term “have” should be interpreted as “having the stated elements but not limited to the stated elements.” Further, the modifier “one (a/an)” should be interpreted as “at least one” or “one or more.”

What is claimed is:

1. A target supply device, comprising:
a reservoir configured to store a liquid target material;
a first electrode electrically connected to the liquid target material stored in the reservoir;
a nozzle having a through-hole through which the liquid target material stored in the reservoir is discharged;
a first power supply configured to apply a first potential to the first electrode;
a circuit electrically connected to the first electrode and configured to suppress a potential variation of the first electrode;
a second electrode provided to face the through-hole in the nozzle; and
a second power supply configured to apply a second potential that is different from the first potential to the second electrode.

2. The target supply device according to claim 1, wherein the circuit includes a capacitor electrically connected at one terminal to the first electrode and at the other terminal to the second potential.

3. The target supply device according to claim 2, wherein the circuit further includes a resistor electrically connected at one terminal to the first electrode and at the other terminal to the second potential.

4. The target supply device according to claim 1, wherein the circuit is electrically connected to the first electrode through a wire electrically connecting the first electrode and the first power supply.

5. The target supply device according to claim 1, wherein:
the reservoir includes a material having electrically conductive properties, and
the first electrode is electrically connected to the liquid target material through the reservoir.

6. The target supply device according to claim 5, wherein the circuit is electrically connected to the first electrode through the reservoir.
